(19) United States
(12) Patent Application Publication
(10) Pub. No.: US 2005/0083828 A1
(43) Pub. Date: Apr. 21, 2005

(54) APPARATUS AND METHOD FOR LASER POWER CONTROL

(76) Inventor: Chih-Yuan Chen, Chang-Hua Hsien (TW)

Correspondence Address: NORTH AMERICA INTERNATIONAL PATENT OFFICE (NAIPC), P.O. BOX 506, MERRIFIELD, VA, 22116, US

(21) Appl. No.: 10/605,680

(22) Filed: Oct. 17, 2003

(51) Int. Cl. G11B 5/09; G11B 7/00

(52) U.S. Cl. 369/116; 369/47.5; 369/59.11

(57) ABSTRACT

A high-speed optical disc recording apparatus includes a laser diode for generating multi-pulse light pulses and a photodiode outputting a measured power of the light pulses. An NRZI pattern encoder generates a predetermined power control pattern causing a write strategy generator to generate write strategy to a laser diode driver such that the laser diode outputs a multi-pulse having a fixed-duty ratio with two power levels. The measured power is averaged with a low-pass filter, is sampled and held, and is calibrated according to the fixed-duty ratio. The calibrated held average output of the measured power of the light pulses is compared with predetermined present levels to control the laser diode driver output voltage.

### BACKGROUND OF INVENTION

1. Field of the Invention

This invention relates to automatic power control in an optical recording apparatus. More specifically, a device and method for controlling laser power during high-speed recording in the optical recording apparatus is disclosed.

2. Description of the Prior Art

During a recording by an optical disc apparatus, a laser diode is used to selectively crystallize a phase-change material comprised by the optical disc. Uniformity in crystallization throughout the optical disc requires uniformity in laser power. However, as shown in FIG. 1, the actual laser power decreases with the same drive current when the temperature increases, necessitating Automatic Power Control (APC).

U.S. Pat. No. 4,685,097, issued to Henk van der Put and included herein by reference, offers one prior art approach to APC. The patent discloses a laser power control in optical recording drives which compares a preset voltage level with the output of a Front Monitor Detector (FMD). The FMD senses a portion of laser power and adjusts the current driving the laser diode such that a desired read, erase, or write power is achieved despite temperature change or aging of the laser diode.

Practically, the FMD disclosed by van der Put is a bandwidth-limited element that can truthfully reflect the laser power it receives after a period of settling time. To sample a settled FMD output during recording pulses, the response of the FMD element must be fast enough for the desired recording rate. However, high cost or practical manufacturing techniques limit the bandwidth of the FMD such that the FMD output cannot achieve a settled level during high-speed recording pulses.

U.S. Pat. No. 4,307,469, issued to Casper et al. and incorporated herein by reference, discloses another method for laser power control but again requires the use a photodiode fast enough to produce an electrical replica of the optical pulse data stream, which vastly increases the costs and may not be possible regardless of costs during high-speed recording.

Taking a Blu-ray disc as an example, the channel bit rate for one reference recording velocity denoted as 1× is 66 Mbits/s, which implies 1 T=15.2 ns. If the bandwidth of the FMD is 20 MHz, the power waveform and the FMD response (Front Photodiode Output (FPDO) in volts) corresponding to a given NRZI signal is shown in FIG. 2. As can be seen, the response speed of the 20 MHz FMD is such that only the erase power level PE can stabilize during the allotted recording periods. Neither the peak write level PW nor the bias level PB are able to achieve stability during their respectively allotted time periods. Hence, only the erase power PE can be controlled by sampling a settled FMD output level.

To have a settled FMD level for PW or PB, the bandwidth of the FMD should be increased to 100 MHz as shown in FIG. 3. Here, the response speed of the FMD is now fast enough to allow accurate sampling of the stabilized FPDO. However, the 100 MHz FMD response time is still not fast enough for higher speed recordings, such as a 12× as shown in FIG. 4. Moreover, if an FMD with a bandwidth of 20 Mhz is used for high-speed recording (e.g. 12×), then it is impossible even to control the erase power since the FPDO does not achieve a settled level during the entire recording period as shown in FIG. 5.

U.S. Pat. No. 6,222,814, issued to lsao Ichimura and incorporated herein by reference, presents a method to solve the aforementioned problem. When in a power control mode, the phase-change optical disc drive generates an output control pulse to generate a light pulse larger in width than the multi-pulse used for high-speed recording. Laser power is detected by a detecting means based on the output control pulse and is controlled such that a sampled and held laser power has a predetermined value. The method is not suitable for high-speed, high-density recordings with narrow track pitch where cross-erase or cross-write easily occur when the recording pulse width is too large.

### SUMMARY OF INVENTION

It is therefore a primary objective of the claimed invention to provide an alternative device and method for laser power control suitable for high density recording in a high-speed optical recording apparatus.

An APC mode may be initiated when recording in an APC area of an optical disc. The present invention includes a laser diode (LD) for generating multi-pulse light pulses having a fixed-duty ratio according to a current or voltage supplied by an LD driver. An encoder/decoder (Endec) controller determines when the APC mode is to be initiated and generates a specific NRZI pattern as required in the APC mode for LD power control. Both the NRZI and an APC mode signals are transmitted to a sample and hold signal generator and to a write strategy generator.

During the APC mode, the write strategy generates and transmits to the LD driver a write strategy such that the laser diode driver causes the laser diode to output a multi-pulse of the fixed-duty ratio with two power levels. The power of the light pulse is detected by the photodiode in a Front Monitor Detector (FMD), which outputs, via a current-to-voltage converter a Front Photo Diode Output (FPDO). A Low-Pass Filter (LPF) is used to average the FPDO. The averaged FPDO is sampled and held by a sample and hold circuit when the sample and hold signal generator issues a sample and hold signal. The actual power can be obtained by multiplying the held average FPDO by a predetermined coefficient equal to the inverse of the fixed-duty ratio. An APC circuit compares the multiplied held average output values with target powers supplied by a CPU to compensate for deviations in the actual laser power level from desired levels by adjusting the voltage or current to the laser diode so that the laser diode is maintained at a constant predetermined power level.

A major advantage of the present invention is the ability to accurately maintain constant laser power levels in high-speed recording without requiring special, width-extended laser pulses which may possibly damage the optical disc, especially in high-density recording.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a chart illustrating the relationship of laser power to required drive current by temperature.

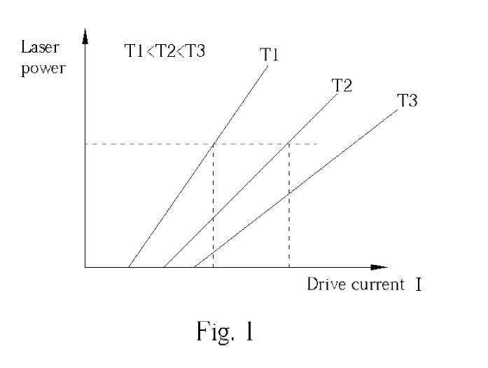

FIG. 2 is a graph illustrating an FPDO from a 20 MHz FMD with Blu-ray 1× recording pulses.

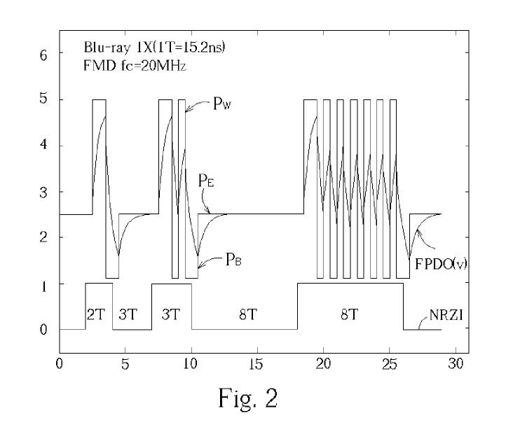

FIG. 3 is a graph illustrating the same conditions as FIG. 2 except with a 100 MHz FMD.

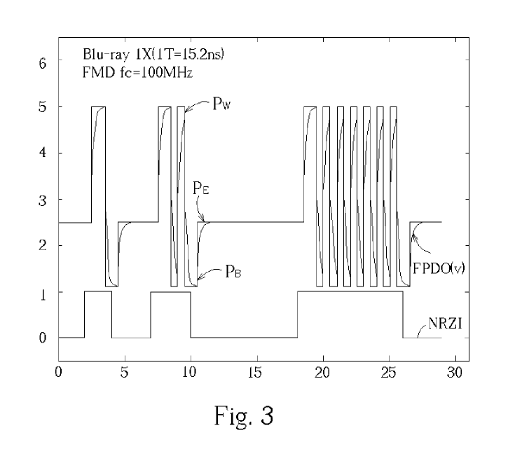

FIG. 4 is a graph illustrating the FPDO from the FMD of FIG. 3 if the recording speed in increased to 12×.

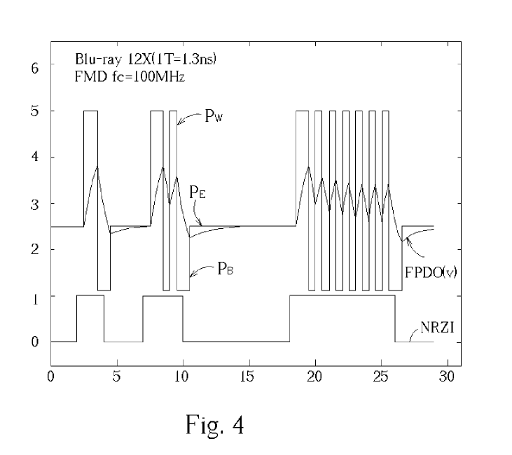

FIG. 5 is a graph illustrating the FPDO of FIG. 2 if the recording speed is increased to 12×.

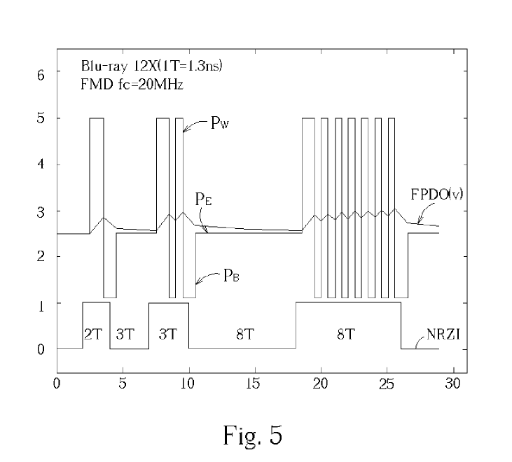

FIG. 6 illustrates data allocation and linking as defined for Blu-ray Disc, Rewritable.

FIG. 7 is a block diagram of the present invention.

FIG. 8 is a graph illustrating an application of the present invention.

FIG. 9 is a waveform chart of the present invention.

FIG. 10 is a waveform chart of a fixed-duty ratio APC according to the present invention.

FIG. 11 is a chart showing the relationship between laser power and FMD output.

FIG. 12 is a waveform chart showing write strategy to obtain bias power levels according to the present invention.

### DETAILED DESCRIPTION

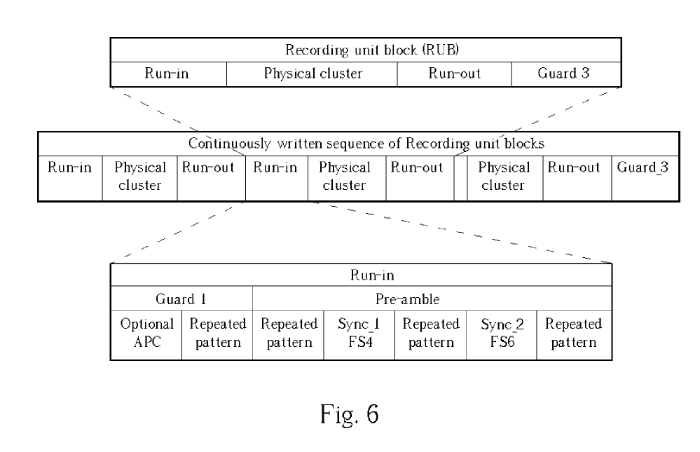

The Blu-ray Disc, Rewritable Format, version 1.0 defines physical data allocation and linking as shown in FIG. 6. A data recording contains a sequence of recording unit blocks. Each recording unit block has a Run-in area and a Run-out area. No data is recorded in the Run-in and Run-out areas. In the Run-in area and the Run-out area (not shown in detail) an optional Automatic Power Control (APC) area is defined for possible application of laser power control. The present invention presents an apparatus and a method of controlling the laser power utilizing the APC area.

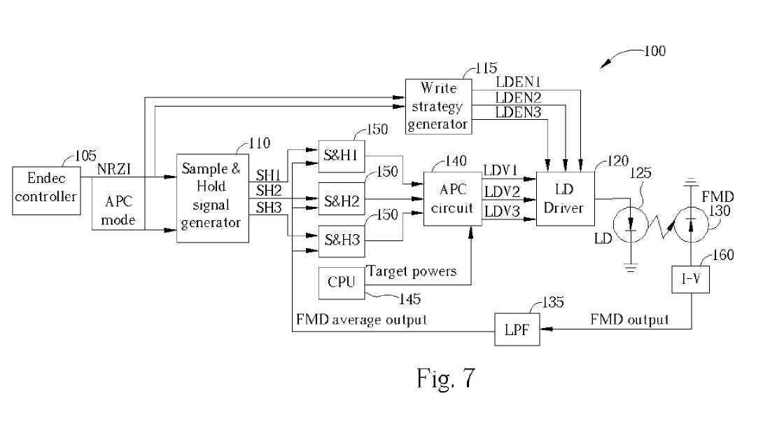

FIG. 7 provides a block diagram of a preferred optical recording apparatus 100 according to the present invention. The apparatus 100 comprises a laser diode (LD) 125 for generating a light pulse according to a current or voltage supplied by a LD driver 120. An FMD 130 detects the power of the light pulse and outputs an FMD output, also known in the art as a Front Photodiode Output (FPDO). The FPDO is transmitted, via a current-to-voltage converter 160, through a Low-pass Filter (LPF) 135 to generate an FMD average output which is sampled and held by sample and hold circuits 150 according to signals generated by a sample and hold signal generator 110. Each sample and hold circuit preferably corresponds to write power (P_{W}), erase power (P_{E}), and bias power (P_{B}) respectively and outputs the held values to an APC circuit 140. The APC circuit 140 utilizes relationships between the held output values and target powers supplied by a CPU 145 to compensate for deviations in the actual laser power level from desired levels.

An encoder/decoder (Endec) controller 105 determines the value of a Non Return to Zero Inverted (NRZI) signal and an APC mode signal. Both the NRZI and the APC mode signals are transmitted to the sample and hold signal generator 110 and to a write strategy generator 115. During the APC mode, the write strategy generator 115 generates and transmits an LDEN1 signal, an LDEN2 signal, and an LDEN3 signal to the LD driver 120 according to which power level of P_{B}, P_{E}, or P_{W} is to be measured.

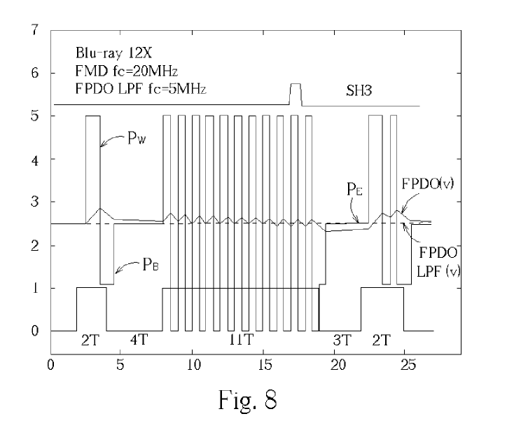

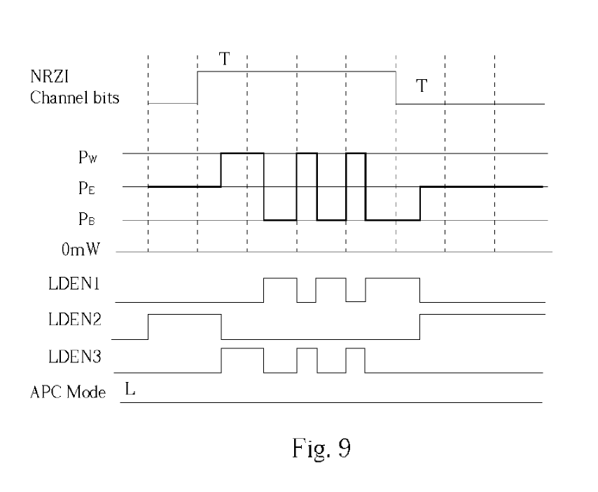

The Endec controller 105 generates a specific NRZI pattern as required in the APC mode for laser power control when recording the APC area. In the APC mode, the NRZI pattern is not constrained to the maximum run length, e.g. 14 T in DVD-R/RW discs and 9 T in Blu-ray discs. The specific NRZI pattern is designed according to the relative relationship between the recording speed and the FMD bandwidth. For a relatively slow FMD response, a larger run length can be selected as shown in FIG. 8, where the 11 T mark length is selected for the purpose of power control. The write strategy generator 115 produces the control signals LDEN1, LDEN2, and LDEN3 used by the Laser Diode (LD) driver for synthesizing the laser power waveform. In a normal recording operation, the laser power waveform can be synthesized by the three drive voltages LDV1, LDV2, and LDV3 from the APC circuit 140 and the three control signals LDEN1, LDEN2, and LDEN3 generated by the write strategy generator 115 as shown in FIG. 9. In this description of an embodiment of the present invention, LDV1 and LDEN1 form the bias power P_{B}, LDV2 and LDEN2 form the erase power P_{E}, and LDV3 and LDEN3 form the peak write power P_{W} respectively.

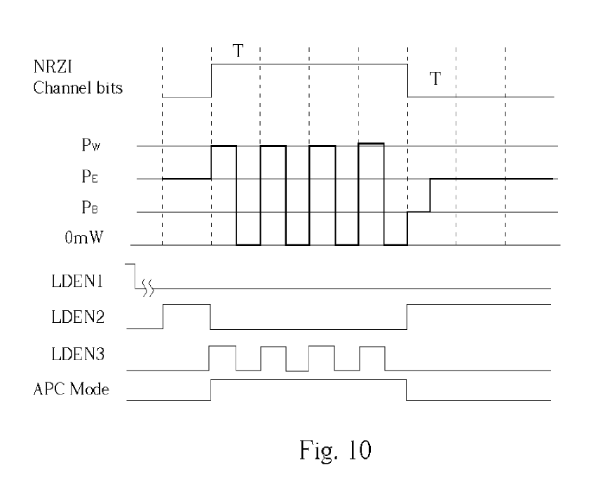

The generated write strategy, along with the optimal write powers, have been well tuned to give the best recording performance. However, in the APC mode, the write strategy generator 115 can be controlled to generate the control signals shown in FIG. 10 such that the laser power output is a fixed-duty pulse with two power levels; one power level to be controlled and zero bias power.

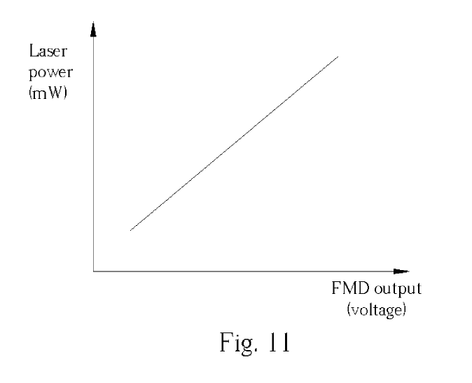

Consider an example case of a fixed-duty ratio of 50% where the fixed-duty ratio represents the ratio of the power level pulse width to the combined pulse widths of the power level and the bias power while in the APC mode. A fixed-duty ratio of 50% would produce an average power P_{avg} of the recording pulse, or here, P_{avg}=P_{W}/2. The average power P_{avg} can be monitored by the average FMD output. The approximately linear relationship between the laser power and the FMD output as shown in FIG. 11 can be easily built through a power calibration procedure. From the relationship curve between the FMD output and the laser power, the actual power P_{W} can be obtained by P_{W}=K*P_{avg} where K is a predetermined coefficient equal to the inverse of the fixed-duty ratio. A fixed-duty ratio of 50% would yield K=2.

The average FMD output is obtained utilizing a signal processor that is capable of averaging the two power levels in the FMD output. In the preferred embodiment shown in FIG. 7, the signal processor is the low-pass filter 135. However, another embodiment may replace the low-pass filter 135 with any type of signal processor that is capable of getting the average FMD output without departing from the spirit of the invention. The sample and hold signal generator 110 in FIG. 7 generates a sample and hold signal SH3 to sample the substantially settled FMD average output of the low-pass filter 135. With a predetermined power level set by the CPU 135 and the sampled and held FMD average output, the APC circuit 140 generates the control voltage LDV3 for maintaining constant the peak write power P_{W}.

FIG. 8 presents a detailed demonstration in the APC mode where an 11 T mark is generated. The generated write strategy results in a write pulse of a 50% duty ratio and the sample and hold signal SH3 sampling the settled output of the low-pass filter 135. The exact specifications of the LPF 135 are design considerations so long as the LPF 135 is capable of substantially stabilizing the FMD output corresponding to the predetermined multi-pulse write strategy used during the APC mode.

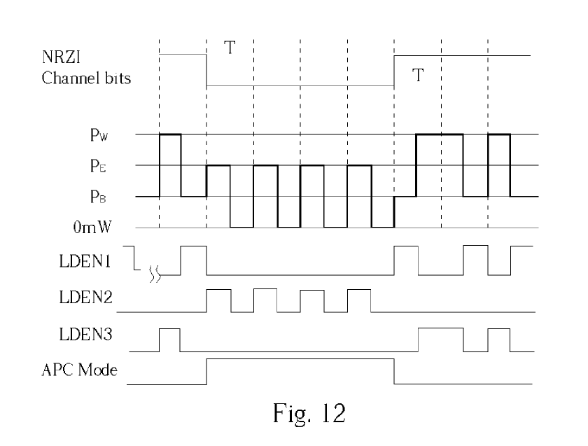

The method of power control for the write strategy described above can also be applied to the erase power P_{E} and the bias power P_{B}. FIG. 12 shows the write strategy applied to the erase power P_{E}. After stabilization of the FMD average output, the sample and hold signal generator 110 issues the sample and hold signal SH2, causing the appropriate sample and hold circuit 150 to sample and hold the substantially stabilized FMD average output. The held P_{E} is then multiplied by a predetermined coefficient that is equal to the inverse of the fixed-duty ratio used when measuring the erase power. The fixed-duty ratio used during the assessment of the write power P_{W} and the fixed-duty ratio used during the assessment of the erase power P_{E} (and that used during the measurement of the bias power P_{B}) are preferably the same, but it is not necessary for the respective ratios to be similar if design considerations suggest alternative values.

A major advantage of the present invention is the ability to accurately maintain constant laser power levels in high speed, multi-pulse recording without requiring special, width-extended laser pulses which may possibly damage the optical disc, especially in high-density recording. Additionally, the present invention is not to be limited to a fixed-duty ratio of 50%, as another fixed-duty ratio may serve adequately, provided the predetermined coefficients are corresponding adjusted. Obviously, it is preferred for the fixed-duty ratio to be less than 1 to avoid disc damage. The importance of the fixed-duty ratio lies not in the exact percentage, but in the ability to control the required laser powers while utilizing multi-pulse, which permits the option of adjusting pulse width within the multi-pulse train according to design considerations and without damage to the optical disc.

The present invention achievesaccurate laser power control for high-speed optical disc recording during APC mode by generating a series of fixed-duty laser pulses. Because the widths of the fixed-duty laser pulses do not vary significantly from the width of laser pulses generated during actual recording modes, the present invention produces no unwanted abnormalities on the optical disc. Thus, the present invention is suitable for high-speed, high-density recordings with narrow track pitch where cross-erase or cross-write easily occur when the recording pulse width is too large. The fixed-duty nature of the present invention laser pulses permits accurate determination of the averaged optical laser output power, which in turn, allows accurate laser power control.

Control for maintaining the respective laser powers constant despite temperature change or aging of the laser diode can be performed sequentially in the APC area by controlling the circuits shown in FIG. 7 to generate the required signals. It is also noted that the claimed power control apparatus and method is not limited to a phase change disc and can also be applied to write-once discs that have an area inside the disc for power control.

Those skilled in the art will readily observe that numerous modifications and alterations of the device and method may be made while retaining the teachings of the invention. Accordingly, the above disclosure should be construed as limited only by the metes and bounds of the appended claims.

1. An optical disc recording apparatus comprising:
an Endec controller, connected to a write strategy generator, for generating a predefined NRZI pattern and an APC mode signal;
a laser diode driven according to the write strategy generator to generate a multi-pulse light pulse having a fixed-duty ratio with two power levels during APC mode;
a photodiode for generating output voltage according to a sensed power of the light pulse; and
a signal processor for averaging the generated output voltage;
wherein the power of the laser diode is controlled according to average generated output voltage occurring during the APC mode.

2. The optical disc recording apparatus of claim 1 wherein the signal processor for averaging the generated output voltage is a low pass filter.

3. The optical disc recording apparatus of claim 1 further comprising a sample and hold signal generator connected to the Endec controller for generating a sample and hold signal when the average generated output voltage has substantially stabilized.

4. The optical disc recording apparatus of claim 3 further comprising at least one sample and hold circuit connected to the low-pass filter and to the sample and hold signal generator for sampling and holding the average generated output voltage according to the sample and hold signal.

5. The optical disc recording apparatus of claim 4 wherein the average generated output voltage held by the sample and hold circuit is multiplied by a predetermined coefficient to control the power of the laser diode.

6. The optical disc recording apparatus of claim 5 wherein the predetermined coefficient is equal to the inverse of the fixed-duty ratio.

7. The optical disc recording apparatus of claim 1 wherein the fixed-duty ratio is less than one.

8. The optical disc recording apparatus of claim 1 wherein the Endec controller initiates the APC mode exclusively within predefined APC areas of the optical disc.

9. The optical disc recording apparatus of claim 1 wherein the laser diode utilizes a Blu-ray, Rewritable standard.

10. A method for controlling laser power in an optical disc recording apparatus, the optical disc recording apparatus comprising a laser diode, a photodiode, and an Endec controller, the method comprising:
initiating an APC mode utilizing the Endec controller;
generating a multi-pulse light pulse having a predetermined fixed-duty ratio and two power levels with the laser diode during the APC mode;
generating photodiode output voltage according to the sensed power of the generated multi-pulse light pulse during the APC mode;
substantially averaging the photodiode output voltage utilizing a signal processor; and
utilizing the substantially averaged photodiode output voltage to control power of the laser diode.

11. The method of claim 10 wherein the predetermined fixed-duty ratio is less than one.

12. The method of claim 11 wherein the substantially averaged photodiode output voltage multiplied by the inverse of the fixed duty ratio is compared to a target power for controlling the power of the laser diode.

13. The method of claim 10 wherein the optical disc recording apparatus further comprises a write strategy generator connected to the Endec controller for causing the laser diode to generate the multi-pulse light pulse during the APC mode.

14. The method of claim 10 wherein the generated multi-pulse light pulse is a first multi-pulse light pulse utilized to measure write power or a second multi-pulse light pulse utilized to measure erase power.

15. The method of claim 10 wherein the Endec controller initiates the APC mode exclusively within a predefined APC area of the optical disc.

16. The method of claim 10 wherein the optical disc recording apparatus utilizes a Blu-ray Disc, Rewritable standard.

17. The method of claim 10 wherein the signal processor for averaging the photodiode output voltage is a low pass filter.

18. A method for controlling laser power in a Blu-ray optical disc recording apparatus when in APC power control mode, the Blu-ray optical disc recording apparatus comprising a laser diode for generating multi-pulse light pulses and a photodiode outputting a measured power of the light pulses, the method comprising:
controlling an NRZI pattern encoder to generate a predetermined power control pattern;
controlling a write strategy generator to generate write strategy to a laser diode driver such that the laser diode outputs multi-pulses having a fixed-duty ratio with two power levels;
sampling and holding an average output of the measured power of the light pulses, the average output of the measured power obtained utilizing a signal processor; and
controlling the laser diode power level according to predetermined present levels and the held average output of the measured power of the light pulses.

19. The method of claim 18 wherein the fixed-duty ratio is less than 1.

20. The method of claim 19 wherein the signal processor for averaging the output of the measured power of the light pulses is a low pass filter.

21. The method of claim 19 wherein the laser diode power level is controlled according to the predetermined present levels and the held average output of the measured power of the light pulses multiplied by the inverse of the fixed-duty ratio.
